(19) United States
(12) Patent Application Publication
(10) Pub. No.: US 2012/0208581 A1
(43) Pub. Date: Aug. 16, 2012

(54) DISTRIBUTED ANTENNA SYSTEM BASE STATION AND RADIO RESOURCE CONTROL METHOD

(75) Inventors: Hitoshi ISHIDA, Fujisawa (JP); Kenzaburo FUJISHIMA, Kokubunji (JP); Yunjian JIA, Yokohama (JP)

(73) Assignee: HITACHI, LTD., Tokyo (JP)

(21) Appl. No.: 13/359,994

(22) Filed: Jan. 27, 2012

(30) Foreign Application Priority Data
Feb. 10, 2011 (JP) 2011-027128

(51) Int. Cl. H04W 4/00; H04W 88/08; H04W 72/04

(52) U.S. Cl. 455/509; 455/517; 455/562.1

(57) ABSTRACT

Disclosed is a distributed antenna system that selects an antenna in accordance with the position of a mobile terminal and reduces the variation in the total number of mobile terminals using each antenna while maintaining adequate communication quality. In the distributed antenna system in which a large number of antennas are distributively disposed, an antenna group including antennas having good communication quality is selected in accordance with the position of a mobile terminal. Further, in accordance with the communication quality and load status of a current antenna group and with the communication quality and load status of a post-change antenna group, which is obtained by changing some antennas in the current antenna group, the post-change antenna group is formed by changing some antennas in the current antenna group with which a mobile terminal using a heavily loaded antenna communicates.

### CLAIM OF PRIORITY

The present application claims priority from Japanese patent application JP 2011-027128 filed on Feb. 10, 2011, the content of which is hereby incorporated by reference into this application.

### FIELD OF THE INVENTION

The present invention relates to a distributed antenna system, a base station, and a radio resource control method. More particularly, the present invention relates to a distributed antenna system in which antennas are distributively disposed, a base station in the distributed antenna system, and a radio resource control method.

### BACKGROUND OF THE INVENTION

It is demanded that the data rate of a cellular system be further increased. Thus, a radio communication system compliant with LTE (Long Term Evolution) specifications, which provide a maximum data rate higher than 100 Mbps, has begun to be commercialized. LTE provides improved multipath resistance by using OFDMA (Orthogonal Frequency Division Multiple Access) for downlink access and SC-FDMA (Single Carrier-Frequency Division Multiple Access) for uplink access. In addition, a MIMO (Multiple-Input Multiple-Output) transmission method, which allows a transceiver and a receiver to use multiple antennas, is introduced to provide increased frequency usage efficiency.

In the cellular system, the communication quality of a cell-edge terminal, which is positioned at a distance from a base station transmitting a desired signal, deteriorates due to a signal power decrease caused by path loss and an interference power increase caused by a decreased distance to a neighboring base station.

To reduce the degree of communication quality deterioration of the cell-edge terminal, that is, the place dependency of communication quality, LTE-Advanced, which is an advanced standard of LTE, is being standardized to offer a CoMP (Coordinated Multi Point transmission and reception) technology and a Relay technology. The CoMP technology provides coordinated transmission and reception between base stations to reduce inter-cell interference. The Relay technology relays a signal transmitted from a base station to expand a coverage area. The LTE-Advanced standard is described in 3GPP, “Feasibility Study for Further Advancements for E-UTRA (LTE-Advanced) (Release 9)”, TR 36.912.V9.3.0, 2010/06, pp. 17-20, http://www 3gpp.org/ftp/Specs/html-info/36912.htm.

A DAS (Distributed Antenna System) is known as another technology for reducing the place dependency of communication quality.

FIG. 1 shows an example of a distributed antenna system. In the distributed antenna system, a large number of base station antennas 1-1 to 1-12 are distributively disposed within a service area. Individual mobile terminals (MTs) 2-1 to 2-6 establish communication by using an antenna group that includes multiple antennas. The antenna group is referred to as a cluster 3. The distributed antenna system is capable of preventing signal power from being decreased by path loss by reducing the distance between the base station antennas and the mobile terminals. This makes it possible to reduce communication quality variation with the position of a mobile terminal (MT). In the distributed antenna system in which the coverage area of a cluster 3 is fixed (a fixed cluster is used) as shown in FIG. 1, however, the communication quality of a mobile terminal positioned at a boundary between clusters, such as a mobile terminal 2-4 shown in FIG. 1, may deteriorate due to significant interference from a neighboring cluster, as is the case with a conventional cellular system.

### SUMMARY OF THE INVENTION

To achieve communication quality independent of the position of a mobile terminal, it is necessary to not only use the distributed antenna system but also select an appropriate antenna group in accordance with the position of each mobile terminal. In other words, it is necessary to form a cluster that dynamically changes in accordance with individual mobile terminals. When such a cluster is formed, it is possible to not only reduce the propagation loss of a desired signal but also increase the propagation loss of an interference signal, thereby improving the SINR (Signal to Interference plus Noise power Ratio). It means that communication quality independent of the position of a mobile terminal can be provided.

A method of selecting an appropriate antenna for each mobile terminal is described in Japanese Unexamined Patent Application Publication No. 2007-53768. According to the method described in Japanese Unexamined Patent Application Publication No. 2007-53768, the capacity of a system can be increased by selecting an appropriate antenna for each mobile terminal.

Factors determining the throughput of each mobile terminal include the amount of available time-frequency resource per mobile terminal in addition to communication quality. An LTE or other cellular system that uses OFDMA or SC-FDMA divides a time or frequency resource to establish communication between mobile terminals belonging to the same cell. Therefore, the amount of available time-frequency resource per mobile terminal decreases in inverse proportion to the number of mobile terminals belonging to each cell. This also holds true for a distributed antenna system having fixed clusters as shown in FIG. 1. In other words, the amount of time-frequency resource per mobile terminal decreases in inverse proportion to the number of mobile terminals belonging to the same cluster.

Meanwhile, in the case of a distributed antenna system having dynamic clusters that permit free antenna selection in accordance with the position of a mobile terminal, a cluster formed for individual mobile terminals may involve a subset of antennas of another cluster. In other words, multiple clusters may share one antenna. If the same antenna transmits data for multiple mobile terminals by using the same time-frequency resource, significant interference may occur between the data transmissions for the mobile terminals. Therefore, it is necessary to divide the time-frequency resource between the clusters sharing the same antenna. As a result, the available time-frequency resource per mobile terminal depends on not only the number of mobile terminals belonging to the same cluster but also the number of mobile terminals that have selected different clusters sharing the same antenna.

When, in the above instance, multiple clusters share the same antenna, the total number of mobile terminals using a certain antenna is the total number of mobile terminals belonging to all clusters sharing the antenna. In general, the total number of mobile terminals using the antenna varies from one antenna to another within a cluster. In the distributed antenna system having dynamic clusters, therefore, the time-frequency resource per mobile terminal decreases in inverse proportion to the maximum total number of mobile terminals using the individual antennas within the clusters. Consequently, if an antenna is selected by a large number of mobile terminals, the amount of time-frequency resource available to each mobile terminal having selected the antenna decreases. In other words, although communication quality is improved by an appropriate antenna selection, the throughput may decrease in some cases due to a decrease in the amount of time-frequency resource.

A load balancing method to be employed when a large number of mobile terminals (loads) are placed in a particular base station area, cell, or sector within a conventional cellular system is described in Japanese Unexamined Patent Application Publication No. Hei 5 (1993)-344048. According to the method described in Japanese Unexamined Patent Application Publication No. Hei 5 (1993)-344048, load balancing is accomplished by changing the connection between an antenna and a base station. More specifically, if load concentration occurs in relation to a base station, the number of antennas connected to the base station is decreased to reduce its coverage area and decrease the number of mobile terminals connected to the base station. Further, the number of antennas connected to a lightly-loaded base station is increased to expand its coverage area and increase the number of mobile terminals connected to the base station.

However, when the square measure or shape of the coverage area of a cell or sector is changed by a conventional method of controlling load balancing between base stations, a mobile terminal previously positioned at the center of the area may be placed at a boundary of a new area. As a result, communication quality may deteriorate. In other words, even after load balancing, the throughput may decrease due to the deterioration of the communication quality. Further, a mobile terminal placed within the coverage area of a new cell or sector due to a change in the square measure or shape of an area need to perform handover to the new cell or sector to which it belongs. It means that multiple mobile terminals simultaneously perform handover procedure. This may result in an increase in the amount of control traffic.

Furthermore, when the conventional load balancing control method is employed, multiple cells or sectors are not supposed to simultaneously share some antennas. Therefore, the conventional load balancing control method cannot be applied to a distributed antenna system that makes an antenna selection in accordance with the position of a mobile terminal.

To address the above-described problem, it is necessary to provide a system that increases the amount of available time-frequency resource per mobile terminal and raises the throughput achievable by mobile terminals by reducing the variation in the total number of mobile terminals using each antenna while maintaining adequate communication quality.

The present invention has been made in view of the above circumstances and improves, for instance, the communication quality of a mobile terminal in a distributed antenna system by selecting an antenna group in accordance with the position of the mobile terminal. The present invention also increases the amount of time-frequency resource available to each mobile terminal and provides increased throughput by reducing the variation in the number of mobile terminals while preventing the deterioration of communication quality.

According to one aspect of the present invention, there is provided a distributed antenna system including a base station that uses a large number of distributively disposed antennas. When an antenna group including multiple antennas having good communication quality is to be selected in accordance with a mobile terminal, the configuration of antennas included in the antenna group and in at least one of the other antenna groups is changed in accordance with the load on the antennas included in the antenna group.

For example, the base station changes some antennas in an antenna group with which a mobile terminal using a heavily loaded antenna communicates, in accordance with the communication quality and load status of a current antenna group and with the communication quality and load status of the antenna group altered by changing some of its antennas.

According to another aspect of the present invention, there is provided a distributed antenna system including a base station that transmits and receives data by using multiple antennas disposed in the distributed antenna system. Multiple clusters including one or more of some of the antennas are formed in accordance with the position of a mobile terminal. At least two clusters share at least one antenna. The base station provisionally determines a first antenna and a second antenna for a first mobile terminal and a first cluster containing the first antenna and the second antenna when a new communication is initiated or a mobile terminal is moved, formulates an overload judgment to determine whether the provisionally determined first and second antennas are overloaded. When the first antenna is judged to be overloaded, the base station selects a third antenna and a fourth antenna as changed communication antennas for a second mobile terminal communicating with the first and third antennas and a second cluster containing the third and fourth antennas as a change destination cluster for load reduction purposes. The base station selects the provisionally determined first and second antennas and the first cluster as the antennas and cluster for the first mobile terminal. The base station conveys at least one of identification information about the selected first and second antennas and identification information about the first cluster to the first mobile terminal, and conducts subsequent communication by using the antennas whose identification information has been conveyed. The base station conveys at least one of identification information about the third and fourth antennas, which are selected as change destinations, and identification information about the second cluster to the second mobile terminal, and conducts subsequent communication by using the antennas whose identification information has been conveyed.

According to another aspect of the present invention, there is provided a base station for a distributed antenna system. The base station transmits and receives data by using multiple antennas disposed in the distributed antenna system in which multiple clusters including one or more of some of the antennas are formed in accordance with the position of a mobile terminal, and at least two clusters share at least one antenna. The base station includes a radio resource control unit that changes some of the antennas communicating with a mobile terminal in accordance with the load status, communication quality, throughput, or data rate of each antenna. The radio resource control unit provisionally determines a first antenna and a second antenna for a first mobile terminal and a first cluster containing the first antenna and the second antenna when a new communication is initiated or a mobile terminal is moved, formulates an overload judgment to determine whether the provisionally determined first and second antennas are overloaded. When the first antenna is judged to be overloaded, the radio resource control unit selects a third antenna and a fourth antenna as changed communication antennas for a second mobile terminal communicating with the first and third antennas and a second cluster containing the third and fourth antennas as a change destination cluster for load reduction purposes. The radio resource control unit selects the provisionally determined first and second antennas and the first cluster as the antennas and cluster for the first mobile terminal. The radio resource control unit conveys at least one of identification information about the selected first and second antennas and identification information about the first cluster to the first mobile terminal, and conducts subsequent communication by using the antennas whose identification information has been conveyed. The radio resource control unit conveys at least one of identification information about the third and fourth antennas, which are selected as change destinations, and identification information about the second cluster to the second mobile terminal, and conducts subsequent communication by using the antennas whose identification information has been conveyed.

According to still another aspect of the present invention, there is provided a radio resource control method for a distributed antenna system that includes a base station. The base station transmits and receives data by using multiple antennas disposed in the distributed antenna system in which multiple clusters including one or more of some of the antennas are formed in accordance with the position of a mobile terminal, and at least two clusters share at least one antenna. The radio resource control method including the steps of: causing the base station to provisionally determine a first antenna and a second antenna for a first mobile terminal and a first cluster containing the first antenna and the second antenna when a new communication is initiated or a mobile terminal is moved; causing the base station to formulate an overload judgment to determine whether the provisionally determined first and second antennas are overloaded; when the first antenna is judged to be overloaded, causing the base station to select a third antenna and a fourth antenna as changed communication antennas for a second mobile terminal communicating with the first and third antennas and a second cluster containing the third and fourth antennas as a change destination cluster for load reduction purposes; causing the base station to select the provisionally determined first and second antennas and the first cluster as the antennas and cluster for the first mobile terminal; causing the base station to convey at least one of identification information about the selected first and second antennas and identification information about the first cluster to the first mobile terminal, and conduct subsequent communication by using the antennas whose identification information has been conveyed; and causing the base station to convey at least one of identification information about the third and fourth antennas, which are selected as change destinations, and identification information about the second cluster to the second mobile terminal, and conduct subsequent communication by using the antennas whose identification information has been conveyed.

In the above-described distributed antenna system, before the provisional determination concerning an antenna change due to an initial access mobile terminal, the base station, upon receipt of an initial access signal from the first mobile terminal, estimates the antenna-specific received power of the initial access signal and sends a response signal to the first mobile terminal. Upon receipt of a mobile terminal-specific identification signal from the first mobile terminal, the base station can identify the first mobile terminal and provisionally determine the first and second antennas (a₁, a₂) for the first mobile terminal and the first cluster (n₁) containing the first and second antennas (a₁, a₂) in accordance with the antenna-specific received power estimated from the initial access signal from the first mobile terminal.

In the above-described distributed antenna system, before the provisional determination concerning an antenna change (detected on the base station side) due to a moved mobile terminal, in a state where the first and second mobile terminals are communicating with the base station by respectively using the zeroth and second antennas (a₀, a₂) and the first and third antennas (a₁, a₃), the base station estimates the reception quality of a candidate antenna to change for each mobile terminal in accordance with a reference signal transmitted from the first and second mobile terminals on a periodic basis or at a predetermined timing. When the first mobile terminal is moved to change the reception quality of each antenna so that the base station detects that the first antenna (a₁), which is a change destination candidate, has higher reception quality for the first mobile terminal than the zeroth antenna (a₀), which is currently engaged in communication, in accordance with the result of estimation of the change destination candidate, the base station can provisionally select the first and second antennas (a₁, a₂) as changed antennas for the first mobile terminal and the first cluster (n₁) containing the first and second antennas (a₁, a₂) as a change destination cluster.

In the above-described distributed antenna system, before the provisional determination concerning an antenna change (detected on the mobile terminal side) due to a moved mobile terminal, the base station transmits a downlink reference signal in such a manner that individual antennas can be distinguished from each other. Each mobile terminal measures the reception quality of a candidate antenna to change in addition to the reception quality of an antenna in a cluster currently engaged in communication by using the downlink reference signal transmitted from the base station. When the first mobile terminal detects that the first antenna (a₁) has higher reception quality than the zeroth antenna (a₀), which is currently engaged in communication, the first mobile terminal notifies the identification information and reception quality information about currently communicating antennas (a₀, a₂) and the identification information and reception quality information about a candidate antenna to change (a₁). In accordance with the result of measurement of the reception quality of each antenna, which is notified from the first mobile terminal, the base station can provisionally select the first and second antennas (a₁, a₂) as changed antennas for the first mobile terminal and the first cluster (n₁) containing the first and second antennas (a₁, a₂) as a change destination cluster.

According to an aspect of the present invention, the distributed antenna system can improve the communication quality of a mobile terminal by selecting an antenna group having low propagation loss in accordance with the position of the mobile terminal. Further, according to an aspect of the present invention, the variation in the number of mobile terminals can be reduced while preventing the deterioration of communication quality by replacing only some antennas in an antenna group having optimal communication quality with suboptimal antennas in accordance with the variation in the number of mobile terminals using each antenna. As a result, an aspect of the present invention makes it possible to increase the amount of available time-frequency resource per mobile terminal and provide increased throughput. In addition, according to an aspect of the present invention, when a communication antenna group change is notified to a mobile terminal by indicating an antenna identifier, the variation in the number of mobile terminals can be reduced without performing a hand-over process.

### BRIEF DESCRIPTION OF THE DRAWINGS

An embodiment of the present invention will be described in detail based on the following figures, in which:

FIG. 1 shows a distributed antenna system having fixed clusters;

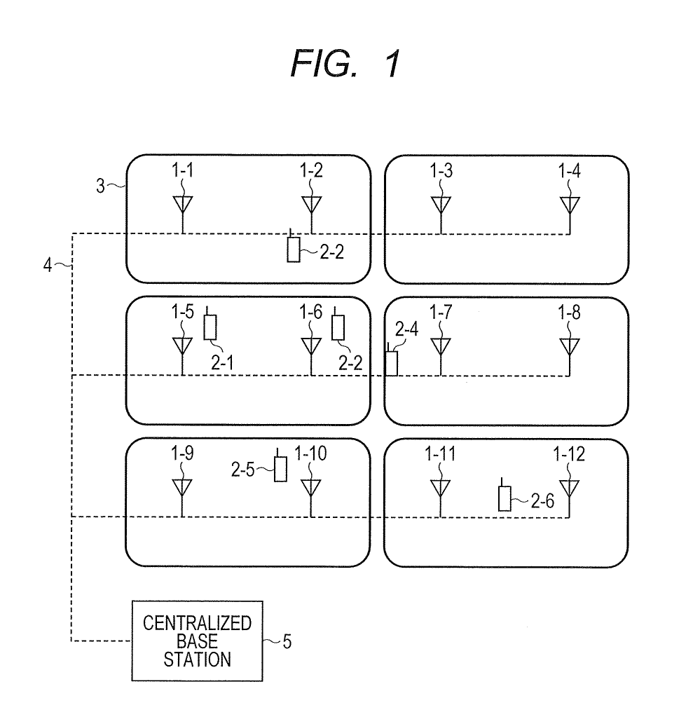

FIG. 2 shows a distributed antenna system that forms dynamic clusters in accordance with the position of a mobile terminal;

FIG. 3 shows an example of time-frequency resource allocation to clusters;

FIG. 4 is a conceptual diagram illustrating a radio resource control method according to an embodiment of the present invention that is used when an antenna change is made;

FIG. 5 shows an example of time-frequency resource allocation to clusters configured after an antenna change;

FIG. 6 is a first exemplary sequence diagram (1) illustrating the sequence of events occurring between the instant at which a initial access mobile terminal arises and the instant at, which an antenna change is made for load reduction;

FIG. 7 is a second exemplary sequence diagram (1) illustrating the sequence of events occurring between the instant at which an antenna change is made due to a moved mobile terminal and the instant at which an antenna change is made for load reduction;

FIG. 8 is a third exemplary sequence diagram (1) illustrating the sequence of events occurring between the instant at which an antenna change is made due to a moved mobile terminal and the instant at which an antenna change is made for load reduction;

FIG. 9 is a diagram illustrating the configuration of a centralized base station that implements a radio resource control method according to the embodiment of the present invention;

FIG. 10 is a first exemplary flowchart illustrating the radio resource control method according to the embodiment of the present invention;

FIG. 11 is a second exemplary flowchart illustrating the radio resource control method according to the embodiment of the present invention;

FIG. 12 shows an example of a management table concerning mobile terminal IDs and candidate antennas to change;

FIG. 13 shows an example of a radio resource management table for managing the relationship between clusters and antennas and the load information about the clusters and antennas;

FIG. 14 shows an example of a cluster management table for managing mobile terminals belonging to each cluster;

FIG. 15 is a first exemplary sequence diagram (2) illustrating the sequence of events occurring between the instant at which a initial access mobile terminal arises and the instant at which an antenna change is made for load reduction;

FIG. 16 is a second exemplary sequence diagram (2) illustrating the sequence of events occurring between the instant at which an antenna change is made due to a moved mobile terminal and the instant at which an antenna change is made for load reduction; and

FIG. 17 is a third exemplary sequence diagram (2) illustrating the sequence of events occurring between the instant at which an antenna change is made due to a moved mobile terminal and the instant at which an antenna change is made for load reduction.

### DETAILED DESCRIPTION OF THE PREFERRED EMBODIMENT

### 1. Distributed Antenna System

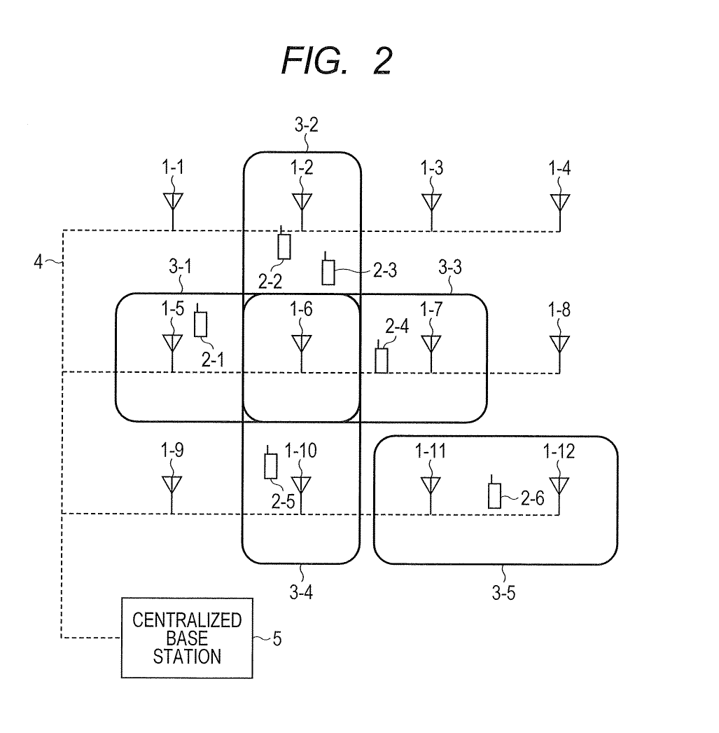

FIG. 2 shows an example of a distributed antenna system having dynamic clusters that select multiple antennas from antennas 1-1 to 1-12 from each mobile terminal in accordance with communication quality.

Mobile terminals 2-1 to 2-6 establish data communication by using antenna groups having multiple antennas, which are among a large number of antennas 1-1 to 1-12 distributively disposed within the system. Referring to FIG. 2, the mobile terminals 2-1 to 2-6 each use two antennas to establish communication. The antenna groups are referred to as clusters 3-1 to 3-5. Each antenna is connected to a centralized base station 5 through an optical fiber or other wired circuit 4. As regards a downlink, data generated by the centralized base station 5 and addressed to multiple mobile terminals is transmitted from multiple antennas at the same time and at the same frequency (hereinafter referred to as “at the same time and frequency”). As regards an uplink, a signal transmitted at the same time and frequency from multiple mobile terminals is received by multiple antennas and transferred to the centralized base station 5.

A cluster 3-1 to 3-5 including an antenna having low propagation loss is selected for individual mobile terminals in accordance with the position of a mobile terminal. This increases the received power of a desired signal and decreases the received power of a signal for another mobile terminal (interference signal). Therefore, the SINR (Signal to Interference plus Noise power Ratio) for the desired signal can be improved.

When an antenna selection is freely made for each of multiple mobile terminals, some or all of the selected antennas are shared between the mobile terminals as shown in FIG. 2. For example, the cluster 3-1 containing antennas 1-5 and 1-6 is selected for the mobile terminal 2-1. Further, cluster 3-2, which contains antennas 1-2 and 1-6, is selected for mobile terminals 2-2 and 2-3. Therefore, only antenna 1-6 is shared between clusters 3-1 and 3-2. If data addressed to multiple mobile terminals is transmitted from the same antenna at the same time and frequency, considerable interference occurs. Therefore, time-frequency resource needs to be divided between mobile terminals sharing all antennas within a cluster, that is, between mobile terminals belonging to the same cluster, as is the case with a conventional cellular system. In cluster 3-2, for instance, the time-frequency resource needs to be divided between mobile terminals 2-2 and 2-3. Further, the time-frequency resource needs to be divided between clusters sharing some antennas only. For example, the time-frequency resource needs to be divided between clusters 3-1 and 3-2. However, clusters sharing no antennas establish communication at the same time and frequency in order to provide increased spatial frequency efficiency. For example, the communication between clusters 3-1 and 3-5 is established at the same time and frequency.

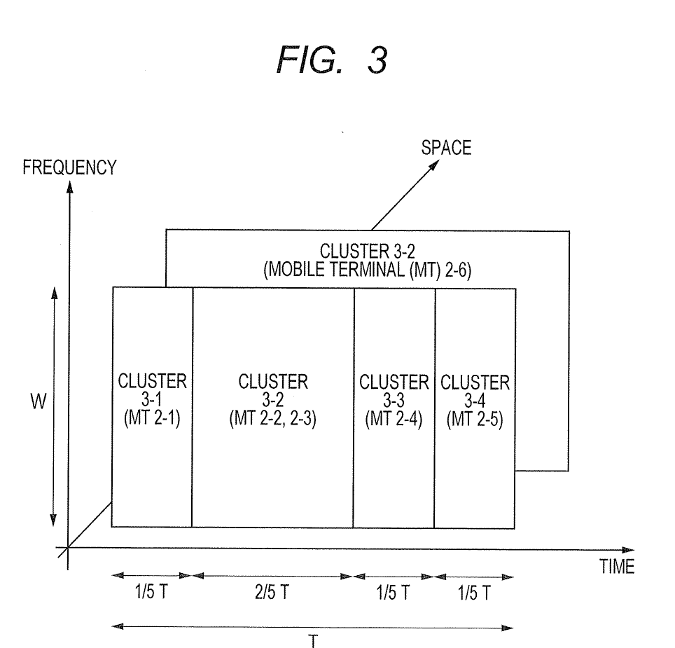

FIG. 3 shows an example of time-frequency resource division between clusters configured as indicated in FIG. 2. In the following description, it is assumed that the time-frequency is normalized so that the time-frequency resource available to the overall system is 1.

Referring to FIG. 2, antenna 1-6 is shared by clusters 3-1, 3-2, 3-3, and 3-4, and the number of mobile terminals belonging to these clusters is 1, 2, 1, and 1, respectively. It means that a total of five mobile terminals use antenna 1-6. As described above, when multiple clusters share an antenna, the total number of mobile terminals using the antenna is equal to the total number of mobile terminals belonging to the clusters sharing the antenna. When, for instance, the time-frequency resource is divided between clusters (clusters 3-1 to 3-4) sharing antenna 1-6 in proportion to the number of mobile terminals belonging to each cluster, the time-frequency resource allocated to clusters 3-1, 3-2, 3-3, and 3-4 is ⅕, ⅖, ⅕, and ⅕, respectively, as shown in FIG. 3. The number of mobile terminals belonging to clusters 3-1, 3-3, and 3-4 is 1. Therefore, the time-frequency resource available to mobile terminals 2-1, 2-4, and 2-5, which belong to clusters 3-1, 3-3, and 3-4, is ⅕. Meanwhile, the number of mobile terminals belonging to cluster 3-2 is 2 (mobile terminals 2-2 and 2-3). If, in the above instance, the time-frequency resource allocated to cluster 3-2, which is ⅖, is equally divided between mobile terminals 2-2 and 2-3, the time-frequency resource available to each of mobile terminals 2-2 and 2-3 is ⅕. Meanwhile, the time-frequency resource available to cluster 3-5, which does not share antennas with any other cluster, is 1. Further, as only mobile terminal 2-6 belongs to cluster 3-5, the time-frequency resource for mobile terminal 2-6 is also 1.

As described above, when multiple clusters share at least one antenna, the available time-frequency resource per cluster is less than the time-frequency resource available to the overall system. Further, the time-frequency resource available to each cluster is divided between mobile terminals belonging to the same cluster. Therefore, if a large number of mobile terminals simultaneously use one antenna, the time-frequency resource per mobile terminal decreases to reduce the throughput of each mobile terminal. Although the time resource is divided between the clusters in the example shown in FIG. 3, an alternative is to divide the frequency resource or divide a combination of the time resource and frequency resource. In the following description, it is assumed for the sake of explanation that communication is established while the time resource is divided between clusters sharing some antennas.

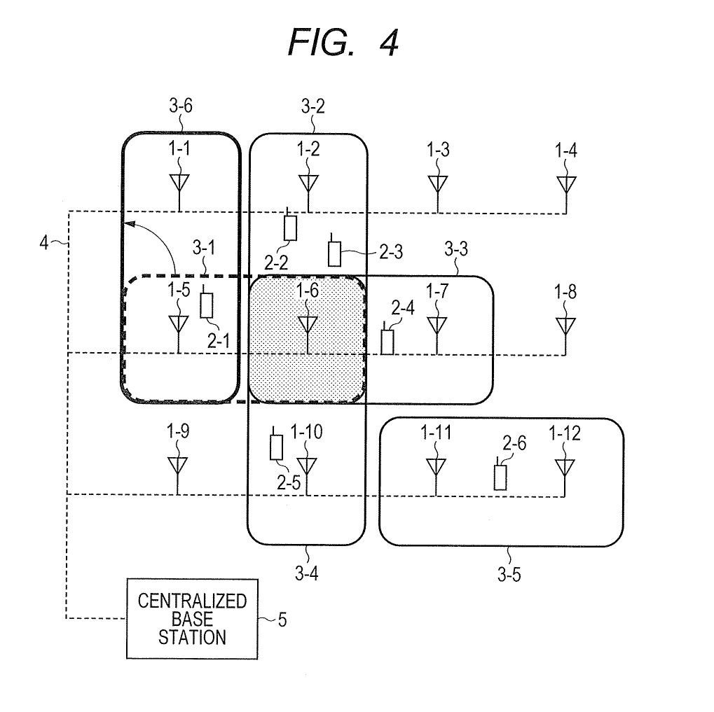

FIG. 4 is a conceptual diagram illustrating a radio resource control method according to an embodiment of the present invention.

The centralized base station 5 monitors the load status such as the total number of mobile terminals using each antenna. When it is found that an antenna is overloaded, the centralized base station 5 performs a process of moving a mobile terminal away from the antenna. However, a currently communicating cluster has good communication quality for the mobile terminal. Therefore, a forced cluster change, that is, a forced antenna change, may significantly deteriorate the communication quality of the mobile terminal. Hence, the centralized base station 5 changes only some antennas in a cluster currently used by the mobile terminal for communication purposes. As a result, the load on the overloaded antenna is reduced while preventing the communication quality from deteriorating.

Referring, for instance, to FIG. 4, antenna 1-6 is heavily loaded because it is selected by a large number of mobile terminals. Therefore, the centralized base station 5 selects a mobile terminal from mobile terminals 2-1, 2-2, 2-3, 2-4, and 2-5, which use the heavily loaded antenna 1-6, as the mobile terminal to be subjected to an antenna change. Referring again to FIG. 4, the centralized base station 5 selects mobile terminal 2-1 as an antenna change target, and changes the cluster for mobile terminal 2-1 from cluster 3-1 (antennas 1-5 and 1-6) to cluster 3-6 (antennas 1-1 and 1-5). In other words, the centralized base station 5 keeps antenna 1-5, and replaces the heavily loaded antenna 1-6 with antenna 1-1, which is lightly loaded. Antenna 1-5 is positioned at a short distance from mobile terminal 2-1 and governing its received power. Therefore, even after the cluster is changed to cluster 3-6, the communication quality of mobile terminal 2-1 does not significantly deteriorate. Further, as the cluster for mobile terminals 2-2 to 2-5 remains unchanged, the communication quality of such mobile terminals does not practically deteriorate. Meanwhile, as mobile terminal 2-1 is moved, the total number of mobile terminals using antenna 1-6 is decreased to reduce the load. As described above, the radio resource control method according to the present embodiment prevents communication quality deterioration and achieves load reduction by changing only some antennas for mobile terminals and by making an antenna change on an individual mobile terminal basis.

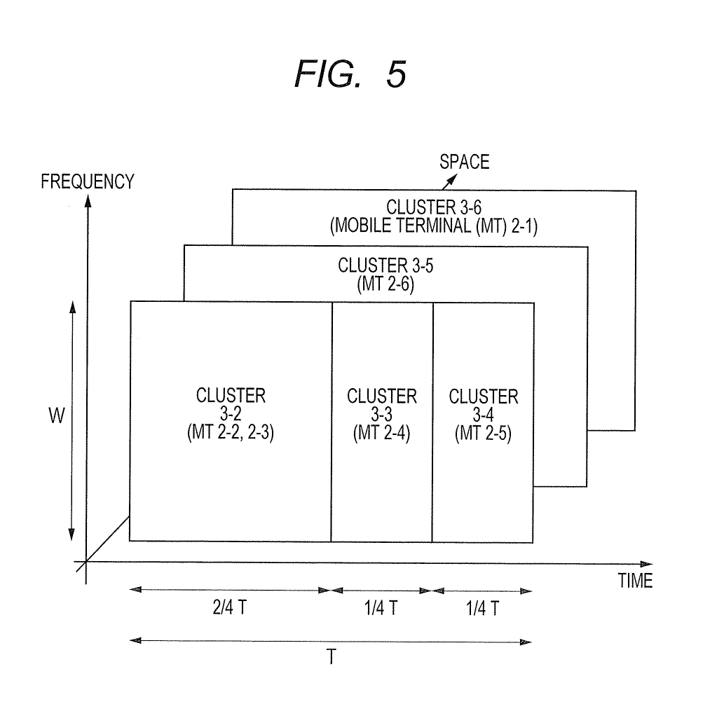

FIG. 5 shows an example of how the resource is divided between clusters after an antenna change.

Referring to FIG. 4, in cluster 3-6 to which mobile terminal 2-1 is changed, no other mobile terminal uses antennas 1-1 and 1-5. Therefore, mobile terminal 2-1 can use the whole time-frequency resource available to the system. As a result, the time-frequency resource for mobile terminal 2-1 is increased to 1 from ⅕, which prevailed before an antenna change. In addition, as a result of the move of mobile terminal 2-1, the total number of mobile terminals using antenna 1-6 is decreased from 5 to 4. Consequently, the time resource allocated to clusters 3-2, 3-3, and 3-4 is increased to 2/4, ¼, and ¼, respectively. Hence, the time-frequency resource for mobile terminals 2-2, 2-3, 2-4, and 2-5 is increased from ⅕ to ¼.

### 2. Sequence for Antenna Change

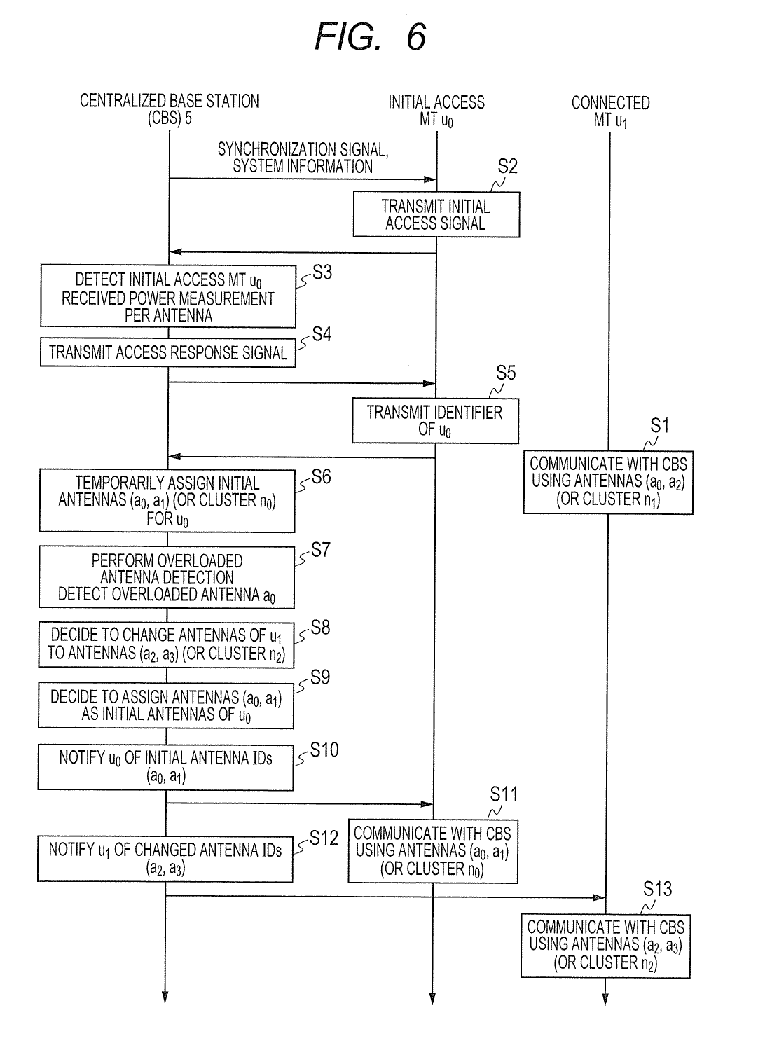

FIG. 6 is a first exemplary sequence diagram (1) illustrating the sequence of events occurring between the instant at which a initial access mobile terminal arises to change antenna load status and the instant at which the centralized base station 5 makes an antenna change for load reduction.

A basic initial access procedure for an initial access mobile terminal conforms, for instance, to that of an LTE system. However, when the initial access mobile terminal attempts to gain initial access, the cluster for data communication is not determined yet. Therefore, initial access steps followed until an antenna identifier (antenna ID) for data communication is notified are performed by using a predetermined antenna or an arbitrarily defined antenna. The simplest method would be to broadcast a signal concerning the initial access sequence with all antennas within the system or perform transmission diversity with a fixed cluster pattern.

The initial access mobile terminal u₀ first receives a synchronization signal and system information broadcast into the system, achieves synchronization acquisition, and acquires the system information. Subsequently, the initial access mobile terminal u₀ transmits an initial access signal (step S2). The system information may include, for instance, a transmission timing, frequency, and signal sequence of initial access signal and a bandwidth used by the system or the like. The initial access signal is transmitted by using the transmission timing, frequency, and signal sequence defined by the system information. The initial access signal corresponds to the random access preamble in the LTE system. The centralized base station 5 receives the initial access signal, and detects that a initial access mobile terminal u₀ exists. Further, the centralized base station 5 estimates the received power of the initial access signal for each antenna (step S3). When the initial access mobile terminal is detected, the centralized base station 5 sends a response signal to the initial access mobile terminal u₀ from all antennas (step S4) (the response signal corresponds to the random access response in the LTE system). Upon receipt of the response signal, the initial access mobile terminal u₀ transmits a mobile terminal-specific identification signal in accordance with the frequency, modulation method, and coding method specified by the response signal (step S5) (the identification signal corresponds to a signal called “Msg3” in the LTE system). When the centralized base station 5 successfully receives the identification signal, it identifies the initial access mobile terminal u₀. The centralized base station 5 then provisionally determines an initial cluster for the initial access mobile terminal u₀ by using the received power of each antenna, which is estimated on the basis of the initial access signal (step S6). For the initial cluster, for example, P antennas are selected beginning with an antenna having the highest received power. Referring, for instance, to FIG. 6, P=2 and cluster n₀ containing antennas a₀ and a₁ is selected as the initial cluster. A cluster ID n₀ is used for cluster management in the centralized base station 5. The following description is given on the assumption that P=2. However, P is not limited to 2 and can be any number.

When the initial access mobile terminal u₀ newly selects antennas a₀ and a₁, the load status of antennas a₀ and a₁ changes.

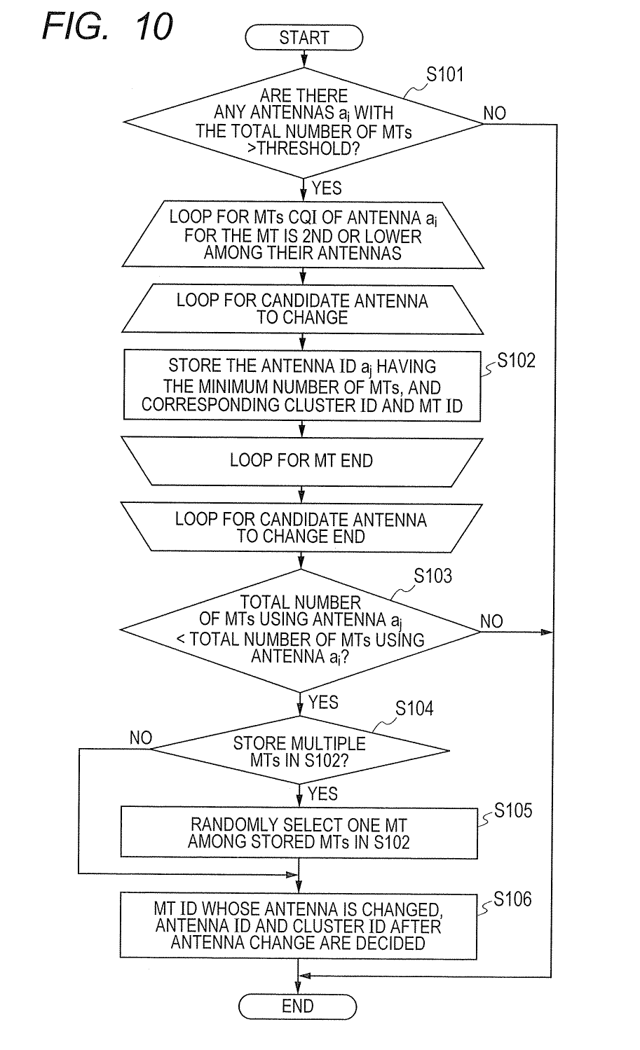

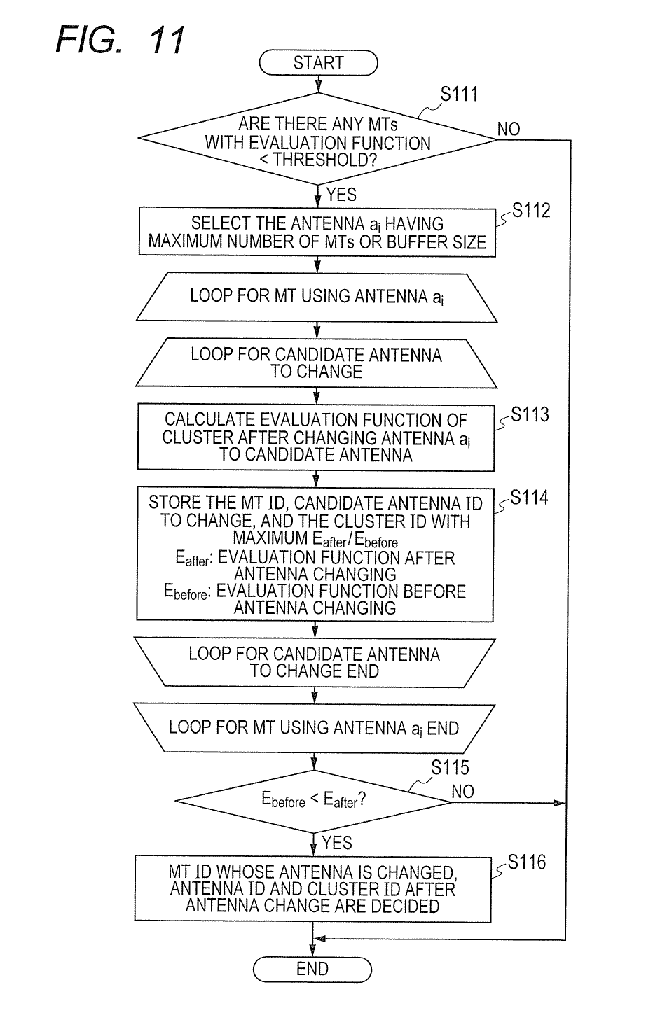

Therefore, the centralized base station 5 formulates an overload judgment about antennas a₀ and a₁ (a detailed description will be given later with reference, for instance, to FIGS. 10 and 11) (step S7). If, for instance, antenna a₀ is judged to be overloaded, the centralized base station 5 performs, on a trial basis, a process of moving a mobile terminal (an connected mobile terminal or the initial access mobile terminal) away from antenna a₀ for load reduction purposes. The centralized base station 5 then determines a mobile terminal ID, a changed antenna ID, and a cluster ID concerning an antenna change target (a detailed description will be given later with reference, for instance, to FIGS. 10 and 11) (step S8). Referring to FIG. 6, the centralized base station 5 selects a connected mobile terminal u₁, which has been engaged in communication (step S1) by using antennas a₀ and a₂, as a mobile terminal targeted for antenna change. The centralized base station 5 then selects antenna a₃ as a changed antenna for antenna a₀ for the connected mobile terminal u₁. In other words, the communication antennas for the connected mobile terminal u₁ change from antennas a₀ and a₂ to antennas a₂ and a₃. Subsequently, the centralized base station 5 selects cluster n₀, which has been provisionally selected as the initial cluster, as the cluster for the initial access mobile terminal u₀ (step S9). Next, the centralized base station 5 notifies the initial access mobile terminal u₀ of antenna IDs (a₀ and a₁) (step S10). The initial access mobile terminal u₀ uses the notified antennas to establish subsequent communication (step S11). In addition, the centralized base station 5 notifies the connected mobile terminal u₁, which is now an antenna change target for load reduction, of changed antenna IDs (a₂ and a₃) (step S12). The connected mobile terminal u₁ uses the notified antennas to establish subsequent communication (step S13).

In the above description, it is assumed that the initial access mobile terminal is different from a mobile terminal to which an antenna change for load reduction is applied. In reality, however, the initial access mobile terminal may be identical with a mobile terminal to which an antenna change for load reduction is applied. In such an instance, the provisionally determined initial cluster is changed by an antenna change process. The initial access mobile terminal is then notified of a changed antenna ID as the antenna ID of the initial cluster. Further, mobile terminal u₁ is will not be notified of an antenna change.

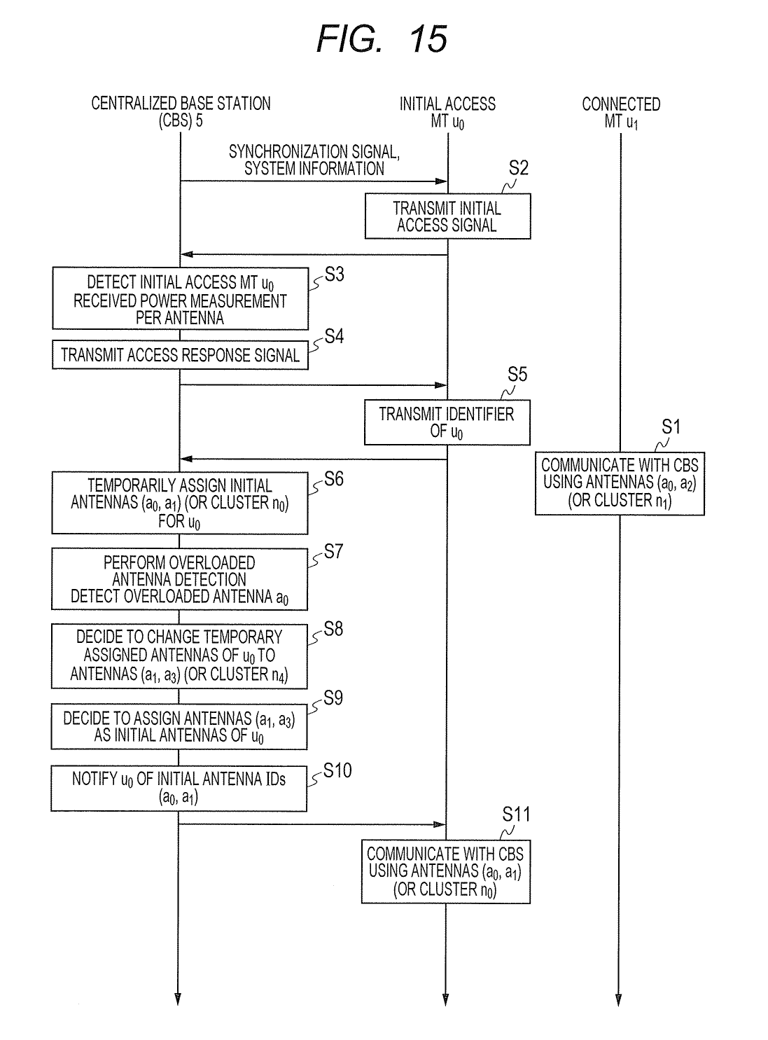

FIG. 15 is a first exemplary sequence diagram (2) illustrating the sequence of events occurring between the instant at which a initial access mobile terminal arises and the instant at which an antenna change is made for load reduction;

If antenna a₀ is judged to be overloaded after the above-described processing steps up to step S6 are performed (step S7), step S8 is performed to achieve load reduction by changing the communication antennas for mobile terminal u₀ to antennas a₁ and a₃ and selecting cluster n₄ containing antennas a₁ and a₃. Next, step S9 is performed to select cluster n₄ as the cluster for mobile terminal u₀. Next, step S10 is performed to notify mobile terminal u₀ of at least one of the identification information about the selected antennas a₁ and a₃ and the identification information about cluster n₄. The notified antennas are then used to establish subsequent communication for mobile terminal u₀.

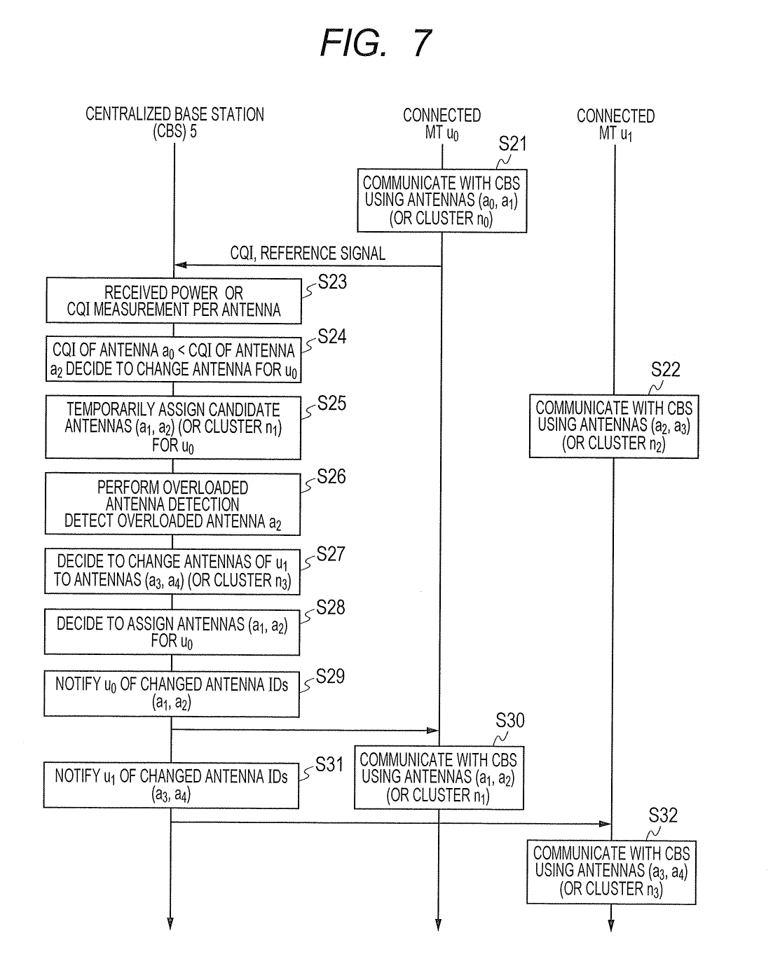

FIG. 7 is a second exemplary sequence diagram (1) illustrating the sequence of events occurring between the instant at which the load status of each antenna changes due to a moved mobile terminal and the instant at which the centralized base station 5 makes an antenna change for load reduction.

Referring to FIG. 7, the initial state is a state where mobile terminals u₀ and u₁ are communicating with the centralized base station 5 by using antennas a₀ and a₁ and antennas a₂ and a₃, respectively (steps S21 and S22).

Each mobile terminal transmits the CQI (Channel Quality Indicator) of a currently communicating cluster and the reference signal, which represents a known sequence for estimating the quality of uplink reception, on a periodic basis or at a predetermined timing. In accordance with the CQI and the reference signal, the centralized base station 5 estimates the reception quality of a candidate antenna to change for each mobile terminal (that is, an antenna positioned around the currently communicating cluster) (step S23). When, for instance, the reception quality of each antenna is changed due to the move of mobile terminal u₀, which has established communication by using antennas a₀ and a₁, the centralized base station 5 detects in accordance with the result of estimation (which will be described in detail later) that the reception quality of antenna a₂ is higher for mobile terminal u₀ than that of antenna a₀, which is currently used for communication (step S24). The centralized base station 5 then performs an antenna change process for mobile terminal u₀ in response to its move. First of all, the centralized base station 5 provisionally determines a change destination cluster (antennas a₁ and a₂) for mobile terminal u₀ (step S25). As mentioned earlier, P antennas (e.g., P=2) are selected beginning with an antenna having the highest received power. As a result, the load status of antenna a₂ changes. Next, the centralized base station 5 judges whether antenna a₂ is overloaded (a detailed description will be given later with reference, for instance, to FIGS. 10 and 11) (step S26).

If antenna a₂, which is a change destination for mobile terminal u₀, is judged to be overloaded, the centralized base station 5 performs, on a trial basis, a process of moving the mobile terminal away from antenna a₂ for load reduction purposes, as is the case where a initial access mobile terminal has arisen. The centralized base station 5 then determines a mobile terminal ID, a changed antenna ID, and a cluster ID, which represent an antenna change target (a detailed description will be given later with reference, for instance, to FIGS. 10 and 11) (mobile terminal ID u₁, changed antenna IDs a₃ and a₄, and cluster ID n₃ are selected in the case shown in FIG. 7) (step S27). Subsequently, the centralized base station 5 notifies mobile terminal u₀, which is to be subjected to antenna change due to its move, and mobile terminal u₁, which is to be subjected to antenna change for load reduction purposes, of a changed antenna ID, and then terminates the process (steps S28 to S32).

In the case shown in FIG. 7, it is assumed that the mobile terminal to be subjected to antenna change due to its move is different from the mobile terminal to be subjected to antenna change for load reduction purposes. In reality, however, these two mobile terminals may be identical with each other. In such an instance, an antenna change process is performed to change the provisionally determined change destination cluster. Mobile terminal u₀ is then notified of a changed antenna ID as the antenna ID of the initial cluster. Further, mobile terminal u₁ will not be notified of an antenna change.

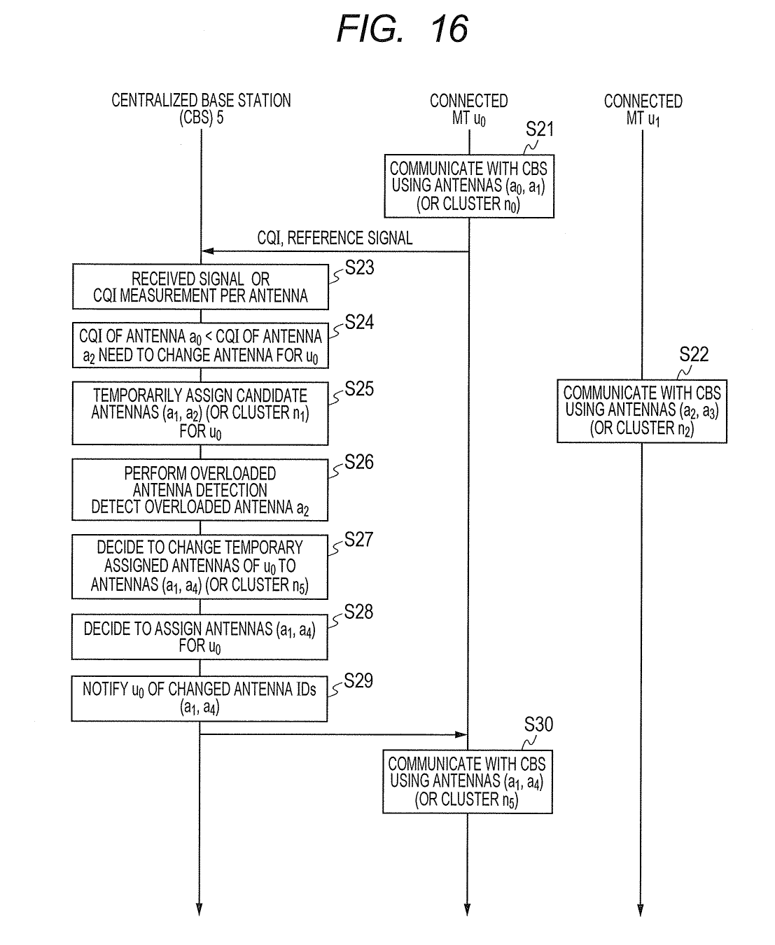

FIG. 16 is a second exemplary sequence diagram (2) illustrating the sequence of events occurring between the instant at which an antenna change is made due to a moved mobile terminal and the instant at which an antenna change is made for load reduction.

If antenna a₂ is judged to be overloaded after the above-described processing steps up to step S6 are performed (step S26), step S27 is performed to achieve load reduction by changing the communication antennas for mobile terminal u₀ to antennas a₁ and a₄ and selecting cluster n₅ containing antennas a₁ and a₄ as a change destination. Next, step S28 is performed to select cluster n₅ as the cluster for mobile terminal u₀. Next, step S29 is performed to notify mobile terminal u₀ of at least one of the identification information about the selected antennas a₁ and a₄ and the identification information about cluster n₅. The notified antennas are then used to establish subsequent communication.

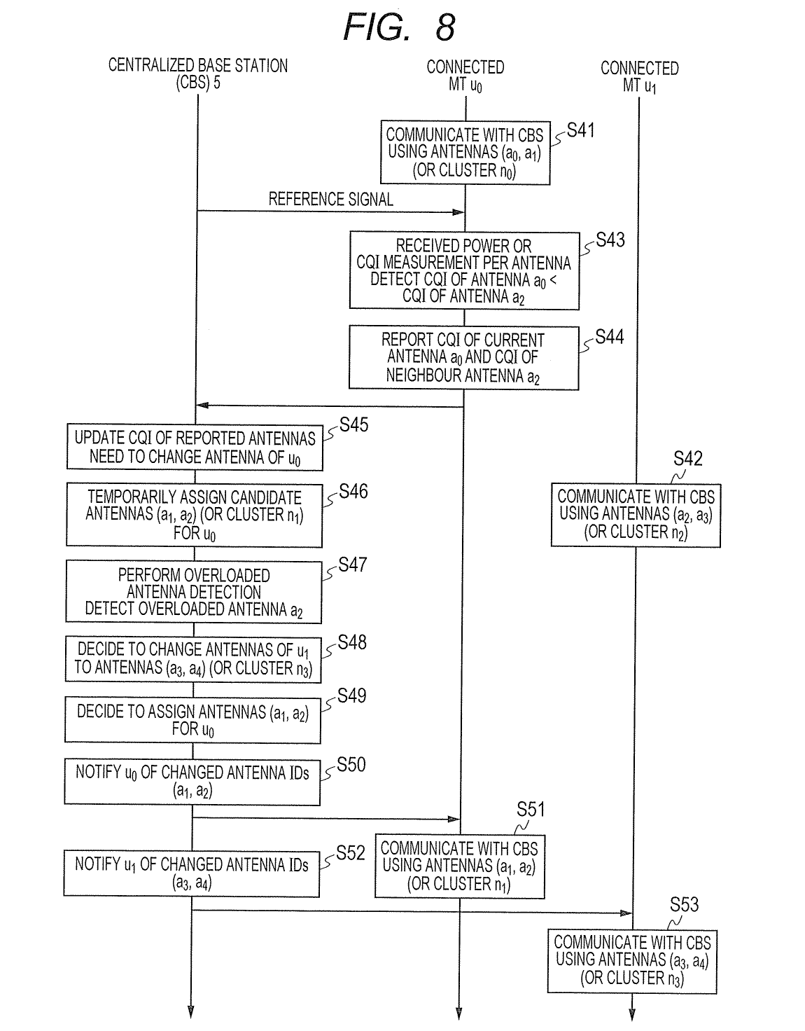

FIG. 8 is a third exemplary sequence diagram (1) illustrating the sequence of events occurring between the instant at which the load status of each antenna changes due to a moved mobile terminal and the instant at which the centralized base station 5 makes an antenna change for load reduction. The example shown in FIG. 8 differs from the example shown in FIG. 7. More specifically, FIG. 7 indicates that the centralized base station 5 estimates the reception quality of each antenna for a mobile terminal by using an uplink reference signal, whereas FIG. 8 indicates that the mobile terminal side measures the reception quality of each antenna and reports the result of measurement to the centralized base station 5. An operation performed by a mobile terminal to measure the reception quality of each antenna and report the result of measurement to the centralized base station 5 is similar to an operation performed by the measurement function of the LTE system. The measurement function of the LTE system is described in TS (Technical Specification) 36.331. The above-described operation performed by the mobile terminal side differs from the operation performed by the measurement function of the LTE system in that the measurement function of the LTE system measures each cell having a cell ID and does not distinguish between antennas, whereas the operation performed by the mobile terminal side reports the reception quality of each antenna after measuring each antenna ID no matter whether it has the same cell ID.

Each mobile terminal measures the reception quality of not only an antenna in a currently communicating cluster but also a candidate antenna to change by using the downlink reference signal transmitted from the centralized base station 5. Referring to FIG. 8, the candidate antenna to change is called a neighbor antenna. The reception quality is averaged by means, for instance, of filtering. However, the centralized base station 5 transmits the downlink reference signal in such a manner as to distinguish between individual antenna IDs. When a periodic event or an event specified by the base station occurs, each mobile terminal reports the results of measurement of the reception quality and an antenna ID associated with each measurement result. The specified event corresponds to a case where the neighbor antenna, which serves as a change destination candidate, has higher reception quality than a currently communicating antenna. An alternative is to further specify a case where, for example, the reception quality of the currently communicating antenna is below a certain threshold value.

Referring to FIG. 8, mobile terminal u₀ makes antenna measurements to detect that antenna a₂ has higher reception quality than antenna a₀, which is currently engaged in communication (step S43). As a result, when a periodic event or an event specified by the base station occurs, mobile terminal u₀ reports the reception qualities of a currently communicating antenna and a neighbor antenna (step S44). The report may include, for instance, the IDs and reception qualities of antennas a₀ and a₁, which are currently engaged in communication, and the ID and reception quality of antenna a₂, which is a change destination candidate. In accordance with the results of measurements of reception qualities of antennas a₀, a₁, and a₂, which are reported from mobile terminal u₀, the centralized base station 5 judges whether mobile terminal u₀ needs an antenna change (a detailed description will be given later with reference, for instance, to FIGS. 10 and 11) (step S45). If the judgment result indicates that an antenna change is needed, the centralized base station 5 provisionally determines a changed antenna for mobile terminal u₀ (a detailed description will be given later with reference, for instance, to FIGS. 10 and 11) (step S46). Next, the centralized base station 5 judges whether antenna a₂, which is a change destination, is overloaded (a detailed description will be given later with reference, for instance, to FIGS. 10 and 11) (step S47). The subsequent operating steps are the same as indicated in FIG. 7.

In the case shown in FIG. 8, too, it is assumed that the mobile terminal to be subjected to antenna change due to its move is different from the mobile terminal to be subjected to antenna change for load reduction purposes. In reality, however, these two mobile terminals may be identical with each other. In such an instance, an antenna change process is performed to change the provisionally determined change destination cluster. Mobile terminal u₀ is then notified of a changed antenna ID as the antenna ID of the initial cluster. Further, mobile terminal u₁ will not be notified of an antenna change.

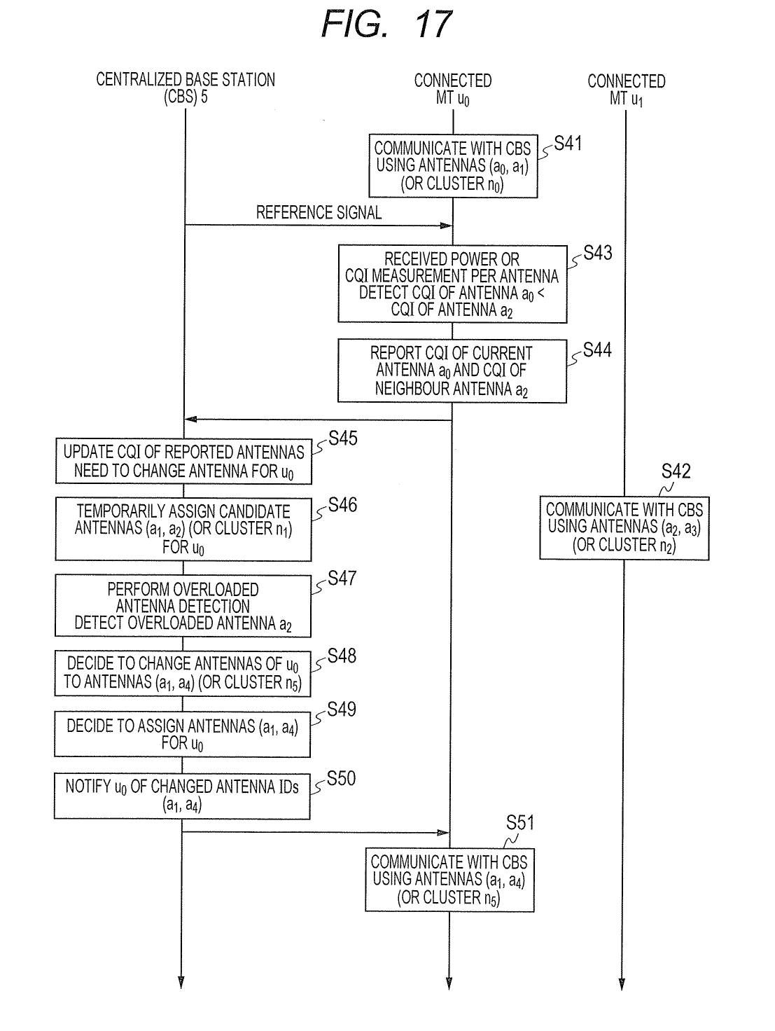

FIG. 17 is a third exemplary sequence diagram (2) illustrating the sequence of events occurring between the instant at which an antenna change is made due to a moved mobile terminal and the instant at which an antenna change is made for load reduction.

If antenna a₂ is judged to be overloaded after the above-described processing steps up to step S46 are performed (step S47), step S48 is performed to achieve load reduction by changing the communication antennas for mobile terminal u₀ to antennas a₁ and a₄ and selecting cluster n₅ containing antennas a₁ and a₄ as a change destination. Next, step S49 is performed to select cluster n₅ as the cluster for mobile terminal u₀. Next, step S50 is performed to notify mobile terminal u₀ of at least one of the identification information about the selected antennas a₁ and a₄ and the identification information about cluster n₅. The notified antennas are then used to establish subsequent communication.

### 3. Centralized Base Station

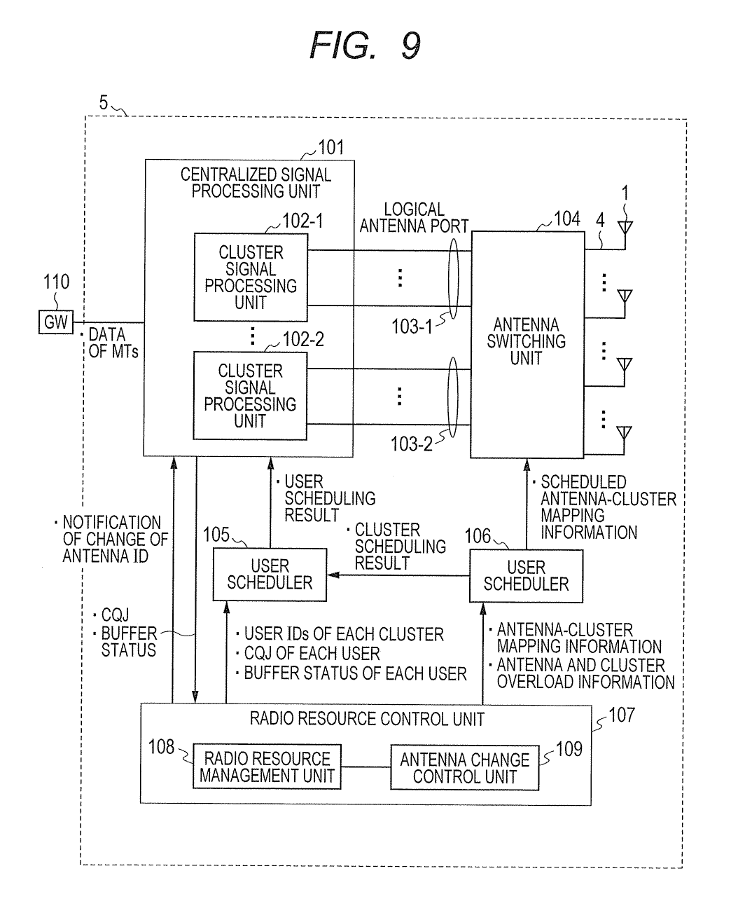

FIG. 9 is a diagram illustrating the configuration of the centralized base station 5 for the distributed antenna system that implements the present embodiment.

A large number of antennas 1 (each antenna 1 is also referred to as an RRH (Remote Radio Head)) are disposed on a plane within the system. Each antenna 1 is connected to an antenna switching unit 104 through the optical fiber or other wired circuit 4. Each antenna 1 transmits a downlink signal, which is output from a centralized signal processing unit 101, and receives an uplink signal, which is transmitted from a mobile terminal.

The antenna switching unit 104 has a router function that freely changes the connections between the antennas 1 and logical antenna ports 103-1, 103-2, which are interfaces for cluster signal processing units 102-1, 102-2 in the centralized signal processing unit 101. Connection control information about the connections between the antennas 1 and the logical antenna ports 103-1, 103-2 for the cluster signal processing units 102-1, 102-2 is input from a cluster scheduler 106. The centralized base station 5 changes the connections to change a communication cluster with time and form a cluster that dynamically changes in accordance with a communication mobile terminal.

The cluster scheduler 106 acquires the antenna ID-to-cluster ID correspondence of the antennas 1 and the load information about each cluster and about each antenna from a radio resource control unit 107. The cluster scheduler 106 then determines the proportion of time resource allocated to each cluster and a combination of clusters for establishing communication at the same time and frequency. When selecting clusters for establishing communication at the same time, the cluster scheduler 106 ensures that the selected clusters do not share the same antenna. A user scheduler 105 and the antenna switching unit 104 are notified of the correspondence between clusters and antennas that establish communication at a certain time (this information is referred to as a cluster scheduling result).

The user scheduler 105 receives the cluster scheduling result from the cluster scheduler 106, and acquires the information about a combination of clusters that establish communication at a certain time. Then, in accordance with the information about mobile terminals belonging to the clusters, the user scheduler 105 determines a communication mobile terminal in each cluster and the communication method for the mobile terminal (e.g., frequency, modulation method, and code rate). The information about a mobile terminal includes, for instance, the CQI and the buffer status. The round robin scheduling method, proportional fairness scheduling method, or other scheduling method used with the conventional cellular system may be used as a user scheduling method. The centralized signal processing unit 101 is notified of the IDs of clusters and mobile terminals that establish communication at a certain time and the method of communication (this information is referred to as a user scheduling result).

The centralized signal processing unit 101 buffers mobile terminal data received from a gateway 110, control information generated in the centralized signal processing unit 101, and antenna ID change notification information from the radio resource control unit 107. Then, in accordance with the user scheduling result, the centralized signal processing unit 101 combines the mobile terminal data and a control signal into a transport block and inputs the transport block into the cluster signal processing units 102-1, 102-2. However, transport blocks addressed to mobile terminals belonging to the same cluster are input into the same cluster signal processing unit.

The cluster signal processing units 102-1, 102-2 perform a MIMO process, including coding, modulating, layer mapping, and precoding, and a signal process, including frequency mapping, on a transport block addressed to each mobile terminal. The cluster signal processing units 102-1, 102-2 perform the above signal processing operations to generate P signal sequences, respectively. The P signal sequences correspond to signal sequences transmitted from P antennas in a cluster. The P signal sequences generated by the cluster signal processing units 102-1, 102-2 are output from the logical antenna ports 103-1, 103-2, respectively. The correspondence between the antenna IDs of antennas in a cluster and the logical antenna ports 103-1, 103-2 should be such that the antenna IDs correlate in ascending order of ID numbers to the logical antenna port numbers 0, 1, . . . , and P-1. However, it is necessary to understand that signal processing on the mobile terminal side is also performed in accordance with the above correspondence. It should also be noted that the signal processing for each mobile terminal is performed in accordance with the user scheduling result.

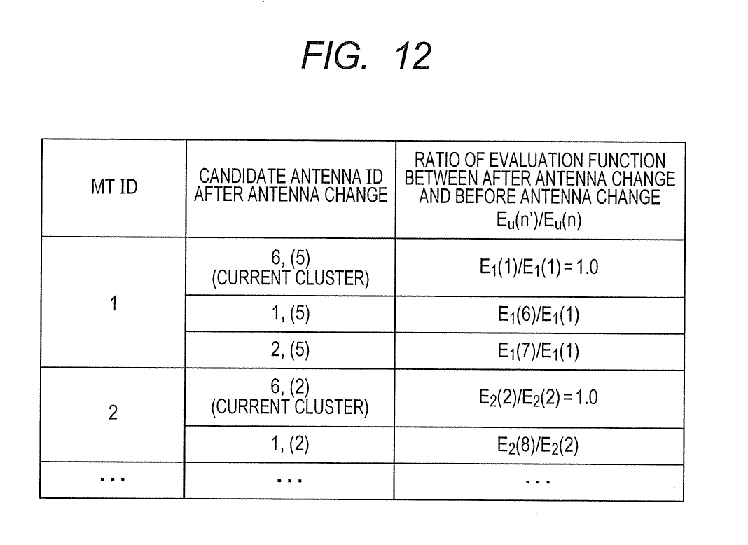

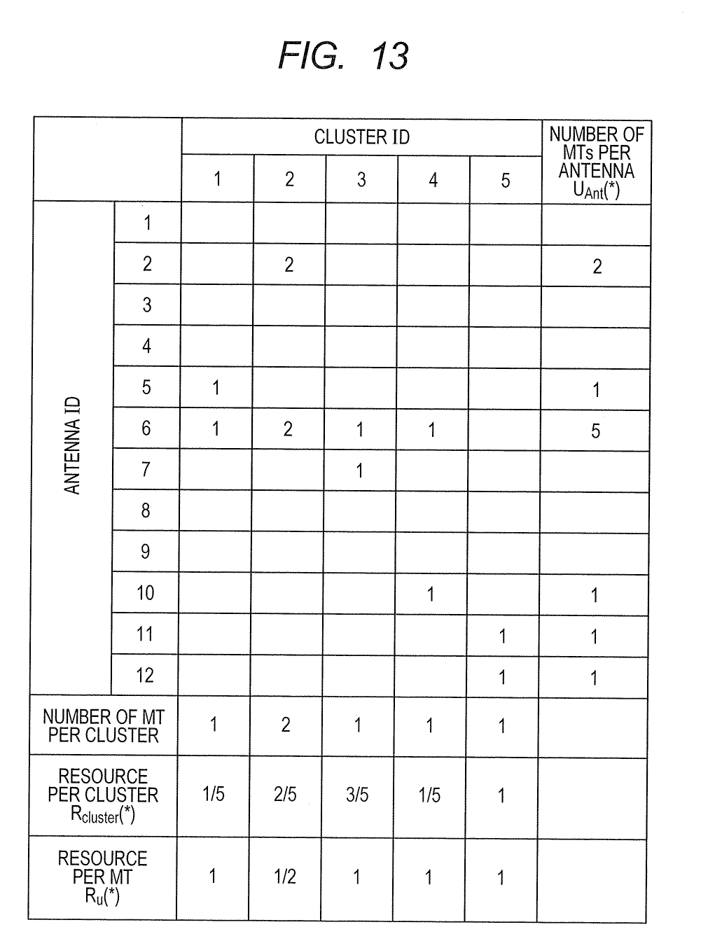

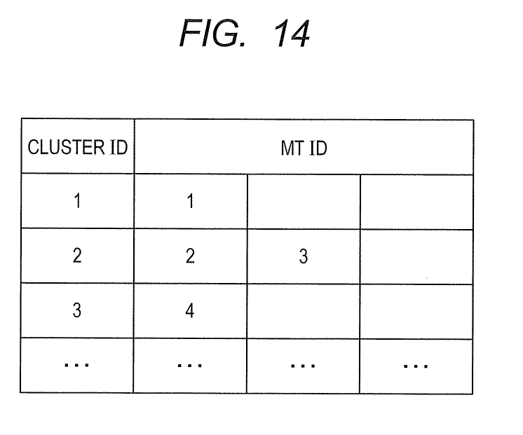

The radio resource control unit 107 is a key component that achieves load reduction by making an antenna change in the present embodiment. The radio resource control unit 107 includes a radio resource management unit 108 and an antenna change control unit 109. The radio resource management unit 108 is a memory that manages the correspondence between clusters and antennas, the load information about each antenna and about each cluster, and the connection information about each mobile terminal. The connection information about each mobile terminal corresponds, for instance, to the IDs of a communicating cluster and a candidate antenna to change and the information about communication quality. The memory will be described later with reference to an antenna management table shown in FIG. 12, a resource management table shown in FIG. 13, and a cluster ID-mobile terminal ID table shown in FIG. 14. The antenna change control unit 109 judges whether each antenna is overloaded. If an antenna is judged to be overloaded, the antenna change control unit 109 checks mobile terminals using the antenna to determine a mobile terminal ID, a changed antenna ID, and a cluster ID that are to subjected to an antenna change. The mobile terminal ID of the mobile terminal to be subjected to an antenna change and the changed antenna ID for the mobile terminal are notified to the centralized signal processing unit 101 as control information addressed to the mobile terminal. Further, the mobile terminal ID of the mobile terminal to be subjected to an antenna change, the changed antenna ID, and the cluster ID are conveyed to the radio resource management unit 108. The radio resource management unit 108 receives such information and updates the load information and mobile terminal connection information in accordance with the received information.

### 4. Overload Judgment-to-Change Destination Determination Flowchart

FIG. 10 is a first exemplary flowchart illustrating operations performed by the antenna change control unit 109 of the radio resource control unit 107. More specifically, this flowchart illustrates the operations performed between the instant at which each antenna is checked to determine whether it is overloaded and the instant at which an antenna change is made for load reduction.

The antenna change control unit 109 judges whether each antenna is overloaded (step S101). More specifically, step S101 is performed to determine whether a threshold value is exceeded by the total number of mobile terminals using each antenna. If the threshold value is exceeded by the total number of mobile terminals using a certain antenna (aᵢ), the antenna change control unit 109 examines mobile terminals using the antenna (aᵢ), and applies an antenna change to a mobile terminal that uses the antenna (aᵢ) as a second or subsequent antenna. The first antenna, the second antenna, and so on to the Pth antenna for a mobile terminal are determined in the descending order of reception quality that is, for example, estimated from the uplink reference signal by a base station or reported from the mobile terminal. A mobile terminal using the antenna (aᵢ) as the first antenna is excluded from antenna change candidates because changing the first antenna is likely to considerably deteriorate the communication quality of the mobile terminal. The antenna change control unit 109 calculates the total number of mobile terminals using candidate antennas to change for the mobile terminal using the antenna (aᵢ) judged to be overloaded. The antenna change control unit 109 performs this operation for all mobile terminals that use the antenna (aᵢ) judged to be overloaded as the second or subsequent antenna. Then, the antenna change control unit 109 memorizes a mobile terminal ID, a changed antenna ID (aⱼ) for a relevant mobile terminal, and a cluster ID that minimizes the total number of mobile terminals using a changed antenna (step S102). An ID of candidate antenna to change and the total number of mobile terminals using the antenna are acquired from the radio resource management unit 108. When the total number of mobile terminals using the changed antenna (aⱼ) is smaller than the total number of mobile terminals using a change source antenna (aᵢ), load reduction can be achieved. Thus, an antenna change is made (step S103). If there are two or more mobile terminals that minimize the total number of mobile terminals using the changed antenna (a), the antenna change control unit 109 selects one mobile terminal at random or by a predefined appropriate method (steps S104 and S105). The antenna change control unit 109 performs the above procedure to determine an antenna change target mobile terminal ID, a changed antenna ID (a), and a cluster ID (step S106). Further, the antenna change control unit 109 conveys antenna change information about the relevant mobile terminal to the radio resource management unit 108. In accordance with the antenna change information, the radio resource management unit 108 updates the connection information and load information about the mobile terminal. In addition, the antenna change control unit 109 operates so that control information for notifying the relevant mobile terminal of an antenna change is conveyed to the centralized signal processing unit.

To prevent the communication quality from being deteriorated by an antenna change, the method described in FIG. 10 limits antenna change targets to mobile terminals using an overloaded antenna as the second or subsequent antenna. However, whether or not an antenna change is to be made is determined depending solely on the total number of mobile terminals using each antenna. In general, there is a trade-off relationship between improving the time-frequency resource per mobile terminal by changing to an antenna used by a small number of mobile terminals and deteriorating the communication quality by changing to an antenna having lower communication quality than a previously used antenna. Therefore, the throughput may conversely decrease after an antenna change. To avoid such a problem, it is necessary to monitor the CQI reported from a mobile terminal after an antenna change or monitor the throughput achieved by the mobile terminal for a predetermined period of time after the antenna change. Further, if the CQI or the throughput is considerably decreased from a level attained before the antenna change, it is necessary to revert to the previous antenna and repeat a process of applying an antenna change to another mobile terminal on a trial basis.

However, it is preferred that the throughput prevailing after a change be predicted wherever possible as indicated in the following example to make an antenna change, thereby minimizing the probability of making antenna change again. Further, the time-frequency resource per cluster and per mobile terminal depends on the user scheduler 105 and the cluster scheduler 106. Therefore, the post-change throughput can be accurately predicted by considering the scheduling methods used by the schedulers.

FIG. 11 is a second exemplary flowchart illustrating operations performed by the antenna change control unit 109 of the radio resource control unit 107. More specifically, this flowchart illustrates the operations performed between the instant at which each antenna is checked to determine whether it is overloaded and the instant at which an antenna change is made for load reduction.

An evaluation function of each mobile terminal is compared against a threshold value to check for an overload.

The evaluation function is expressed, for instance, by Equation (1) below:

Eᵤ(n)=Cᵤ(n)R_{cluster}(n)Rᵤ(n) (1)

where Cᵤ(n) is a term dependent on the reception quality of a cluster n for a mobile terminal u. For example, Shannon's channel capacity or spectrum efficiency tabulated in correspondence with the SINR can be used as this term. The channel capacity and SINR are calculated in accordance with the CQI reported from the mobile terminal and the received power of each antenna or with the received power estimated from the uplink reference signal. R_{cluster} (n) is a term dependent on the time-frequency resource allocated to the cluster n and is determined depending on the cluster scheduler. Rᵤ(n) is a term dependent on the time-frequency resource allocated to the mobile terminal u in the cluster n and is determined depending on the user scheduler. Therefore, R_{cluster}(n)Rᵤ(n) represents the time-frequency resource per mobile terminal.

When an evaluation function in Equation (1) is used, the evaluation function Eᵤ(n) represents an expected throughput value of each mobile terminal. In other words, an increase in the total number of mobile terminals using a certain antenna decreases R_{cluster}(n) and Rᵤ(n), thereby decreasing the expected throughput of a mobile terminal using the antenna or decreasing an expected data rate value. Meanwhile, a deterioration in the reception quality of each antenna decreases Cᵤ(n) and similarly decreases the expected throughput value of the mobile terminal. The radio resource control method according to the present embodiment applies an antenna change to a certain mobile terminal to increase R_{cluster}(n)Rᵤ(n) and raise the throughput achievable by the mobile terminal while inhibiting the decrease in (n). In addition, the antenna change applied to the mobile terminal increases R_{cluster}(n)Rᵤ(n) of a mobile terminal using a change source antenna. Meanwhile, Cᵤ(n) remains unchanged in this instance. This raises the throughput of the mobile terminal using the change source antenna.

For example, the following values can be used as R_{cluster}(n) and Rᵤ(n).

When cluster scheduling is to be performed to allocate the time resource in proportion to the number of mobile terminals belonging to each cluster as shown in FIGS. 3 and 5, R_{cluster}(n) is given by Equation (2) below:

$${R}_{cluster} ( n ) = {U}_{cluster} ( n ) / {max}_{p ∈ \{ 0 , … , P - 1 \}} \{ {U}_{Ant} ( {n}_{p} ) \} \qquad ( 2 )$$

where nₚ is an antenna ID corresponding to a logical antenna port p of the cluster n, P is the number of logical antenna ports of the cluster n, U_{cluster}(n) is the number of mobile terminals belonging to the cluster n, and U_{Ant}(nₚ) is the total number of mobile terminals using antenna nₚ.

Further, when the round robin or proportional fairness scheduling method is used for user scheduling, the time-frequency resource allocated to mobile terminals is approximately equal between mobile terminals belonging to the same cluster. Therefore, Rᵤ(n) is determined by dividing the numerical value 1 by the number of mobile terminals belonging to the cluster n as indicated in Equation (3) below:

Rᵤ(n)=1/U_{cluster}(n) (3)

When cluster scheduling is to be performed to equally divide the time resource between clusters sharing an antenna in another example, R_{cluster}(n) can be expressed by Equation (4) below:

$${R}_{cluster} ( n ) = 1 / {max}_{p ∈ \{ 0 , … , P - 1 \}} \{ N ( {n}_{p} ) \} \qquad ( 4 )$$

where N(nₚ) is the number of clusters sharing antenna nₚ and P is the number of base station side antennas used by one mobile terminal. P may be either fixed or variable. For example, P may be fixed by the system for each mobile terminal or variable and indicative of the number of antennas whose reception quality or reception strength is above a predetermined threshold value or within a predetermined threshold value range.

Further, when cluster scheduling is to be performed to allocate the time resource in proportion to the total buffer status for mobile terminals belonging to each cluster, R_{cluster} (n) can be expressed by Equation (5) below. Similarly, when user cluster scheduling is to be performed to allocate the time-frequency resource in proportion to the buffer status for each mobile terminal, Rᵤ(n) can be expressed by Equation (6) below:

$$\begin{matrix}{R}_{cluster} ( n ) = {B}_{cluster} ( n ) / {max}_{p ∈ \{ 0 , … , P - 1 \}} \{ {B}_{Ant} ( {n}_{p} ) \} & ( 5 ) \\ {R}_{u} ( n ) = {B}_{u} / {B}_{cluster} ( n ) & ( 6 )\end{matrix}$$

where B_{cluster}(n) is the total amount of buffer for mobile terminals belonging to the cluster n, B_{Ant}(nₚ) is the total amount of buffer for mobile terminals using antenna nₚ, and Bᵤ is the amount of buffer for mobile terminal u.

The antenna change control unit 109 checks each mobile terminal to judge whether the above-described evaluation function is below a threshold value (step S111). If the evaluation function of a certain mobile terminal is below the threshold value, the antenna change control unit 109 concludes that a certain antenna used by the mobile terminal is overloaded. The antenna change control unit 109 then selects an antenna (aᵢ) having the maximum total number of mobile terminals U_{Ant}(nₚ) or the maximum total amount of buffer B_{Ant}(nₚ) from antennas in a cluster to which the mobile terminal belongs and designates the selected antenna (aᵢ) as an overloaded antenna (step S112). In accordance with information stored in the radio resource management unit 108, the antenna change control unit 109 performs a calculation on a mobile terminal using the overloaded antenna (aᵢ) to determine the evaluation function prevailing when the overloaded antenna (aᵢ) is replaced by a candidate antenna to change (step S113). The evaluation function is calculated relative to all candidate antennas to change for the mobile terminal. Further, the same calculation is performed on all mobile terminals using the overloaded antenna. Next, the antenna change control unit 109 memorizes a mobile terminal ID, changed antenna ID, and cluster ID that maximize a post-antenna-change evaluation function divided by pre-antenna-change evaluation function (i.e., the rate of evaluation function increase upon an antenna change) (step S114). When the evaluation function is to be calculated, for instance, in step S113, an alternative is to store the evaluation function increase rate (post-change evaluation function/pre-change evaluation function) in a later-described table shown, for instance, in FIG. 12, reference the table in step S114, and determine the mobile terminal ID, ID of candidate antenna to change, and cluster ID that maximize the evaluation function increase rate or provide an evaluation function increase rate higher than a predetermined threshold value. If the evaluation function prevailing after an antenna change for the relevant mobile terminal is improved from the one prevailing before the antenna change, the antenna change control unit 109 effects the antenna change for load reduction purposes (step S115). The antenna change control unit 109 then decides on the memorized mobile terminal ID, changed antenna ID, and cluster ID of a change target (step S116). However, if the evaluation function does not improve, the antenna change control unit 109 does not effect the antenna change because it concludes that higher throughput can be achieved by using the previously employed cluster for communication.

When the evaluation function indicative of an expected throughput value or transmission speed value is used in addition to a list of antennas arranged in the order of quality (e.g., the first antenna, the second antenna, and so on) as described above to predict the throughput of the relevant mobile terminal that prevails after an antenna change, it is possible to decrease the probability of the throughput being conversely deteriorated by the antenna change.

Further, the evaluation function may be calculated by using a method other than indicated by Equation (1). For example, the evaluation function may be weighted in accordance with the number of clusters sharing the overloaded antenna, which is a change source, and with the reduction rate of the amount of total buffer.

### 5. Radio Resource Management Unit Table

FIG. 12 shows a management table of candidate antenna to change that the radio resource management unit 108 uses to manage candidate antennas to change. The management table of candidate antenna to change includes mobile terminal IDs, IDs of current antenna and candidate antenna to change, and evaluation function increase rates prevailing after an antenna change. The candidate antennas to change indicated in the table represent a predetermined number of antennas having relatively high reception quality for each mobile terminal or antennas whose reception quality does not deviate from the reception quality of a currently communicating antenna by more than a predetermined threshold value. When the relevant reception quality information is received or estimated or when a communication antenna for each mobile terminal is changed, the antenna ID and evaluation function increase rate of a change destination candidate are updated.

FIG. 13 shows an example of a resource management table that the radio resource management unit 108 uses to manage the correspondence between cluster IDs and antenna IDs and the time-frequency resource of each cluster and of each antenna.

The resource management table includes cluster IDs, antenna IDs, the load information about each antenna and about each cluster, and the time-frequency resource of each cluster and of each mobile terminal. The cluster-to-antenna correspondence is managed by using a matrix where each row represents an antenna ID and each column represents a cluster ID. Each matrix component indicates load information about a relevant cluster. The information is stored in an antenna row corresponding to each cluster column (although FIG. 13 shows the number of mobile terminals, it may be substituted by the buffer status). In other words, each cluster includes antennas whose row component exists. For example, cluster ID 1 includes antenna IDs 5 and 6 and one mobile terminal. Further, the sum of individual row components represents the total number of mobile terminals using a relevant antenna (the number of mobile terminals/antenna). The time-frequency resource per cluster (resource/cluster) is given by Equation (2), (4), or (5) depending on the method employed by the cluster scheduler. Equation (2) is used in the example shown in FIG. 13. The time-frequency resource per mobile terminal (resource/mobile terminal) for each cluster is given by Equation (3) or (6) (Equation (3) is used in the example shown in FIG. 13). Each component in the table is updated when an initial access mobile terminal arises or antenna change is made due to a moved mobile terminal or for load reduction. If existing cluster IDs do not provide a selected combination of antenna IDs, a new cluster ID column is added. If the number of mobile terminals is currently zero (0) for a previously selected cluster ID, the row component of a relevant antenna ID is zero (0) in the column of the cluster ID. Further, when a new antenna is added to the system, an antenna ID row is added.

In the above example, a cluster ID is adaptively added in accordance with an antenna ID combination selected for each mobile terminal. An alternative is to predetermine a combination of cluster IDs and antenna IDs and limit antenna ID combinations selectable by mobile terminals by the predetermined cluster IDs.

In accordance with the matrix of cluster IDs and antenna IDs in the above-described resource management table, the cluster scheduler 106 selects multiple clusters communicating at the same time and frequency in such a manner that no antenna ID is shared. In other words, the cluster scheduler 106 selects multiple clusters from the matrix table in such a manner that no row is shared.

FIG. 14 shows a cluster ID-mobile terminal ID table for managing the IDs of mobile terminals belonging to each cluster. This table includes the IDs of clusters and the IDs of mobile terminals belonging to each cluster. The user scheduler 105 and the radio resource control unit 107 use this table to reference the mobile terminals belonging to each cluster.

It should be understood by those skilled in the art that various modifications, combinations, sub-combinations, and alterations may occur depending on design requirements and other factors insofar as they are within the scope of the appended claims or the equivalents thereof.

1. A distributed antenna system comprising:
a base station that transmits and receives data by using a plurality of antennas disposed in the distributed antenna system, a plurality of clusters including one or more of some of the antennas being formed in accordance with the position of a mobile terminal, at least two clusters sharing at least one antenna,
wherein the base station performs an operation comprising:
when a new communication is initiated or a mobile terminal is moved, provisionally determining a first antenna and a second antenna for a first mobile terminal and a first cluster containing the first antenna and the second antenna;
formulating an overload judgment to determine whether the provisionally determined first and second antennas are overloaded;
when the first antenna is judged to be overloaded, selecting a third antenna and a fourth antenna as changed communication antennas for a second mobile terminal communicating with the first and third antennas and a second cluster containing the third and fourth antennas as a change destination cluster for load reduction purposes;
selecting the provisionally determined first and second antennas and the first cluster as the antennas and cluster for the first mobile terminal;
conveying at least one of identification information about the selected first and second antennas and identification information about the first cluster to the first mobile terminal and conducting subsequent communication by using the antennas whose identification information has been conveyed; and
conveying at least one of identification information about the third and fourth antennas, which are selected as change destinations, and identification information about the second cluster to the second mobile terminal and conducting subsequent communication by using the antennas whose identification information has been conveyed.

2. The distributed antenna system according to claim 1, wherein, when the first antenna is judged to be overloaded, the distributed antenna system performs an operation comprising:
selecting, for load reduction purposes, the second and fourth antennas as antennas for the first mobile terminal and a third cluster containing the second and fourth antennas as a cluster;
selecting the second and fourth antennas and the third cluster as antennas and cluster for the first mobile terminal; and
conveying at least one of identification information about the selected second and fourth antennas and identification information about the third cluster to the first mobile terminal and conducting subsequent communication by using the antennas whose identification information has been conveyed.

3. The distributed antenna system according to claim 1, wherein, before the provisional determination, the base station performs an operation comprising:
upon receipt of an initial access signal from the first mobile terminal, estimating the antenna-specific received power of the initial access signal and sending a response signal to the first mobile terminal; and
upon receipt of a mobile terminal-specific identification signal from the first mobile terminal, identifying the first mobile terminal and provisionally determining the first and second antennas (a₁, a₂) for the first mobile terminal and the first cluster (n₁) containing the first and second antennas (a₁, a₂) in accordance with the antenna-specific received power estimated from the initial access signal from the first mobile terminal.

4. The distributed antenna system according to claim 1, wherein, before the provisional determination, in a state where the first and second mobile terminals are communicating with the base station by respectively using the zeroth and second antennas (a₀, a₂) and the first and third antennas (a₁, a₃), the base station performs an operation comprising:
estimating the reception quality of a candidate antenna to change for each mobile terminal in accordance with a reference signal transmitted from the first and second mobile terminals on a periodic basis or at a predetermined timing; and
when the first mobile terminal is moved to change the reception quality of each antenna to let the base station detect that the first antenna (a₁), which is a change destination candidate, has higher reception quality for the first mobile terminal than the zeroth antenna (a₀), which is currently engaged in communication, in accordance with the result of estimation of the change destination candidate, provisionally selecting the first and second antennas (a₁, a₂) as changed antennas for the first mobile terminal and the first cluster (n₁) containing the first and second antennas (a₁, a₂) as a change destination cluster.

5. The distributed antenna system according to claim 4, wherein the reference signal includes a CQI (Channel Quality Indicator) and a reference signal that is a known sequence for estimating the quality of uplink reception.

6. The distributed antenna system according to claim 1, wherein, before the provisional determination, the base station transmits a downlink reference signal in such a manner that individual antennas can be distinguished from each other; wherein each mobile terminal measures the reception quality of a candidate antenna to change in addition to the reception quality of an antenna in a currently communicating cluster by using the downlink reference signal transmitted from the base station; wherein, when the first mobile terminal detects that the first antenna (a₁) has higher reception quality than the zeroth antenna (a₀), which is currently engaged in communication, the first mobile terminal reports the identification information and reception quality information about currently communicating antennas (a₀, a₂) and the identification information and reception quality information about a candidate antenna to change (a₁); and wherein the base station provisionally selects the first and second antennas (a₁, a₂) as changed antennas for the first mobile terminal and the first cluster (n₁) containing the first and second antennas (a₁, a₂) as a change destination cluster in accordance with the result of measurement of the reception quality of each antenna, which is reported from the first mobile terminal.

7. The distributed antenna system according to claim 6, wherein each mobile terminal reports the identification information and reception quality information about currently communicating antennas and the identification information and reception quality information about a candidate antenna to change on a periodic basis or when the candidate antenna to change has higher reception quality than a currently communicating antenna or the currently communicating antenna has lower reception quality than a threshold value.

8. The distributed antenna system according to claim 1, wherein, in the provisional determination, the base station forms a cluster by selecting a predetermined number of antennas having relatively high received power or selecting antennas having received power equal to or higher than a predetermined threshold value or within a predetermined range.

9. The distributed antenna system according to claim 1, wherein the base station performs an operation comprising:
formulating an overload judgment by checking whether a threshold value is exceeded by the total number of mobile terminals using each antenna;
when the threshold value is exceeded by the total number of mobile terminals using a certain antenna, performing calculations on all mobile terminals using an antenna judged to be overloaded and candidate antennas to change as second or subsequent antennas to determine the total number of mobile terminals using the relevant antenna;
memorizing the identification information about a mobile terminal, the identification information about a changed antenna for the mobile terminal, and the identification information about a cluster that minimize the total number of mobile terminals using the changed antenna; and
when the total number of mobile terminals using the changed antenna is smaller than the total number of mobile terminals using a previously used antenna, determining the identification information about a mobile terminal to be subjected to an antenna change, the identification information about the changed antenna, and the identification information about the cluster.

10. The distributed antenna system according to claim 1, wherein the base station performs an operation comprising:
judging whether an evaluation function indicative of an expected throughput value or transmission speed value of each mobile terminal is below a threshold value;
when the evaluation function of a certain mobile terminal is below the threshold value, checking antennas in a cluster to which the mobile terminal belongs in order to select an antenna having the maximum total number of mobile terminals or the maximum amount of buffer as an overloaded antenna;
performing calculations on mobile terminals using candidate antennas to change for the mobile terminals and an antenna judged to be overloaded to determine an evaluation function prevailing when the antenna is replaced by a candidate antenna to change;
memorizing the identification information about a mobile terminal, the identification information about a newly selected antenna, and the identification information about a cluster that maximize the rate of evaluation function increase upon an antenna change; and
when the evaluation function prevailing after an antenna change for the mobile terminal is improved from the one prevailing before the antenna change, selecting the memorized pieces of identification information as the identification information about a mobile terminal to be subjected to the antenna change, the identification information about a changed antenna, and the identification information about a cluster.

11. The distributed antenna system according to claim 10, wherein the evaluation function used for overload judgment is calculated using the following equation:
Evaluation function Eᵤ(n)=Cᵤ(n)R_{cluster}(n)Rᵤ(n)
where Cᵤ(n) is a term dependent on the reception quality of cluster n for mobile terminal u, R_{cluster}(n) is a term dependent on time-frequency resource allocated to cluster n, and Rᵤ(n) is a term dependent on the time-frequency resource allocated to mobile terminal u in cluster n.

12. A base station comprising:
a plurality of antennas that form clusters in accordance with the position of a mobile terminal, are shared by at least two of the clusters, and communicate data with the mobile terminal;
wherein an operation performed by the base station includes
provisionally determining a first antenna and a second antenna for a first mobile terminal and a first cluster containing the first antenna and the second antenna when a new communication is initiated or a mobile terminal is moved,
formulating an overload judgment to determine whether the provisionally determined first and second antennas are overloaded,
when the first antenna is judged to be overloaded, selecting a third antenna and a fourth antenna as changed communication antennas for a second mobile terminal communicating with the first and third antennas and a second cluster containing the third and fourth antennas as a change destination cluster for load reduction purposes,
selecting the provisionally determined first and second antennas and the first cluster as the antennas and cluster for the first mobile terminal,
conveying at least one of identification information about the selected first and second antennas and identification information about the first cluster to the first mobile terminal and conducting subsequent communication by using the antennas whose identification information has been conveyed, and
conveying at least one of identification information about the third and fourth antennas, which are selected as change destinations, and identification information about the second cluster to the second mobile terminal and conducting subsequent communication by using the antennas whose identification information has been conveyed.

13. The base station according to claim 12, further comprising:
a centralized signal processing unit that includes a plurality of logical antenna ports and processes signals for a plurality of clusters;
a cluster scheduler that determines a plurality of clusters for communicating at the same time and at the same frequency;
a user scheduler that determines a method of communicating with a mobile terminal in each cluster; and
an antenna switching unit that changes the connections between a plurality of antennas and the logical antenna ports of the centralized signal processing unit in accordance with the result of scheduling provided by the cluster scheduler.

14. A radio resource control method for a distributed antenna system that includes a base station, the base station transmitting and receiving data by using a plurality of antennas disposed in the distributed antenna system in which a plurality of clusters including one or more of some of the antennas are formed in accordance with the position of a mobile terminal, at least two clusters sharing at least one antenna, the radio resource control method comprising the steps of:
when a new communication is initiated or a mobile terminal is moved, causing the base station to provisionally determine a first antenna and a second antenna for a first mobile terminal and a first cluster containing the first antenna and the second antenna;
causing the base station to formulate an overload judgment to determine whether the provisionally determined first and second antennas are overloaded;
when the first antenna is judged to be overloaded, causing the base station to select a third antenna and a fourth antenna as changed communication antennas for a second mobile terminal communicating with the first and third antennas and a second cluster containing the third and fourth antennas as a change destination cluster for load reduction purposes;
causing the base station to select the provisionally determined first and second antennas and the first cluster as the antennas and cluster for the first mobile terminal;
causing the base station to convey at least one of identification information about the selected first and second antennas and identification information about the first cluster to the first mobile terminal and conduct subsequent communication by using the antennas whose identification information has been conveyed; and
causing the base station to convey at least one of identification information about the third and fourth antennas, which are selected as change destinations, and identification information about the second cluster to the second mobile terminal and conduct subsequent communication by using the antennas whose identification information has been conveyed.
